(19) United States
(12) Patent Application Publication
(10) Pub. No.: US 2014/0201046 A1
(43) Pub. Date: Jul. 17, 2014

(54) DATA RECOVERY PRICING METHOD AND DATA BACKUP AND RECOVERY METHOD

(71) Applicant: ASIGRA INC., Toronto (CA)

(72) Inventors: David Farajun, Toronto (CA); Eran Farajun, Toronto (CA); Kelly Peters, Oakville (CA)

(73) Assignee: ASIGRA INC., Toronto (CA)

(21) Appl. No.: 14/102,054

(22) Filed: Dec. 10, 2013

Related U.S. Application Data
(60) Provisional application No. 61/753,698, filed on Jan. 17, 2013.

(51) Int. Cl. G06Q 30/02; G06Q 30/04

(52) U.S. Cl. CPC G06Q 30/0284; G06Q 30/04
USPC 705/34; 705/418

(57) ABSTRACT

A method for pricing data recovery for a sequence of time periods based on an estimate of the amount of data that will be recovered. For the first period, the price is the backup capacity times a price rate times an assumed recovery rate, which is a pre-determined number. For subsequent periods, the price is the backup capacity times the price rate times the actual amount of data recovered in the prior time period. The method also includes a data backup and recovery method using the data recovery pricing method, which provides tracker software to measure the amount of data recovered.

### FIELD OF THE INVENTION

The present invention relates generally to methods for data recovery pricing and data backup and recovery methods, and more particularly to such methods where the price for a subsequent time period is calculated based on the actual amount of data recovered in the prior time period.

### BACKGROUND OF THE INVENTION

Corporate customers may have hundreds or thousands of data storage devices used in association with their computer systems. Such customers will often contract with a service provider to provide a mechanism to backup all or a portion of their data to a safe location, which is typically on hard drives accessible over a network, such as the internet in which case it is sometimes referred to as cloud-based storage. The service provider then also facilitates the recovery of the backed up data by the users, such as when a user has unintentionally deleted some files, or has had a hard drive crash. It is this ability to recover the data that provides value to the users. The service provider may provide effectively unlimited backup storage capacity to each customer or may allocate a fixed amount of backup capacity to each customer, and the customer will pay the service provider a monthly or annual fee to allow the user to backup data based on the amount of data backed up during that period, and to recover that data. Typically, the customer is allowed to recover any amount of the backed up data for a fixed price paid to the service provider that is a function of the amount of backup capacity used by or allocated to that customer. The fixed price is generally calculated as the allocated backup capacity for the customer times a price per storage capacity unit (such as X dollars per terabyte per time period, such as per month).

In reality, the cost of providing such a service may vary depending on the amount of data that is actually recovered, for example due to the network bandwidth utilization, and the amount recovered can vary widely from one customer to another. One customer may only recover 5% of its data capacity in a year, whereas another may recover 25%. When the pricing of the service does not take this into account, some customers are inevitably paying much more than they should, and others may be paying less than they should. However, customers want a fixed price, or at least a fixed upper limit (or “cap”) on the price, for the next time period before they make the decision to purchase the service for that period, so it is difficult to charge based on the amount of data recovered.

In some cases, a service provider may license a software backup and recovery solution from a software licensor. The software licensor may charge the service provider a license fee based on the amount of data backed up and recovered per time period, which may be calculated in a manner similar to the calculation of the fees payable to the service provider by its customers. In this context, the service provider may be referred to as the customer of the software licensor. The customer may also be referred to as the licensee.

### SUMMARY OF THE INVENTION

The following presents a simplified summary of the disclosure in order to provide a basic understanding to the reader. This summary is not an extensive overview of the disclosure and it does not necessarily identify key/critical elements of the invention or delineate the scope of the invention. Its sole purpose is to present some concepts disclosed herein in a simplified form as a prelude to the more detailed description that is presented later.

The present invention provides a data recovery pricing method for pricing the recovery of data that has been backed up by a user to a data repository. The user has a backup capacity BC(n) for time period n, time period 1 being a first continuous time period and time period n being a continuous time period following time period n−1, where n is a positive integer greater than 1. BC(n) defines the maximum amount of data, expressed as a number of storage capacity units, that the user is permitted to store on the backup repository during time period n. BC(n) is a positive real number. The pricing method calculates, using a computer processor, a Recovery Price for period n, RP(n), as:
RP(1)=BC(1)*TARR*RPR(1), where IARR is a pre-defined real number greater than or equal to 0 referred to as the Initial Assumed Recovery Rate, and RPR(n) is a Recovery Price Rate for time period n representing a pre-determined amount of money for each storage capacity unit; and
for n greater than 1, RP(n)=max{MMRR, DRR(n−1)}*f(BC(n))*RPR(n), where MMRR is a pre-defined number greater than or equal to 0 referred to as the Minimum Mandatory Recovery Rate, DRR(n−1) is the Data Recovery Rate for period n−1 that is calculated as the number of storage capacity units of data that were recovered by the user in time period n−1 divided by BC(n−1), and f is a real-valued monotonically non-decreasing positive function.

IARR may be 0.25.

MMRR may be 0 so that, for n>1, RP(n)=DRR(n−1)*f(BC(n))*RPR(n).

MMRR may be 0.05.

Time period n may be a continuous time period immediately following time period n−1.

If DRR(n) exceeds DRR(n−1) then RP(n) may be increased to min{DRR(n), MDRR}*f(BC(n))*RPR(n), where MDRR is the maximum data recovery rate, which is a pre-defined real number greater than or equal to MMRR. MDRR may be equal to IARR. MDRR may be equal to 0.25.

The storage capacity unit may be a byte, kilobyte, megabyte, gigabyte, terabyte or petabyte, for example.

Each of the time periods may be equal to one hour, each of the time periods may be equal to one day, each of the time periods may be equal to one month or each of the time periods may be equal to one year:

The length of each of the time periods may be a function of the number of storage capacity units of data that were recovered by the user since the beginning of that time period.

The function f may be the identify function, so that f(BC(n))=BC(n).

The invention also provides a data backup and recovery method using the data recovery pricing method described above, the data backup and recovery method comprising:
(a) providing a data repository to which a user can backup data and from which the user can recover data;
(b) providing a tracker, the tracker being software for running on a computer processor that measures the number of storage capacity units of data that the user recovers from the data repository; and
(c) for at least time periods n=1 and n=2, calculating RP(n) using the method of claim 1, and charging the user a price equal to RP(n) for time period n, which for n greater than 1 is based on DRR(n−1) measured by the tracker.

The data backup and recovery method may further comprise the step of providing a license server, the license server being software running on a computer processor configured to verify that the user has a valid license to recover data from the data repository.

The invention also provides a data recovery pricing method for pricing the recovery of data that has been backed up by a user to a data repository. The user has a backup capacity BC(n) for time period n, time period 1 being a first continuous time period and time period n being a continuous time period following time period n−1, where n is a positive integer. BC(n) defines the maximum amount of data, expressed as a number of storage capacity units, that the user is permitted to store on the backup device during time period n. BC(n) is a positive real number. The pricing method calculates a Recovery Price for period n, RP(n), as:
RP(1)=BC(1)*IARR*RPR(1), where IARR is a pre-defined real number greater than or equal to 0 referred to as the Initial Assumed Recovery Rate, and RPR(n) is a Recovery Price Rate for time period n representing a pre-determined amount of money for each storage capacity unit; and
for n greater than 1, RP(n)=g(max{MMRR, min{MDRR, DRR(n−1)}})* f(BC(n))*RPR(n), where MMRR is a pre-defined number greater than or equal to 0 referred to as the Minimum Mandatory Recovery Rate, MDRR is the maximum data recovery rate, which is a pre-defined real number greater than or equal to MMRR, DRR(n−1) is the Data Recovery Rate for period n−1 that is calculated as the number of storage capacity units of data that were recovered by the user in time period n−1 divided by BC(n−1), and f and g are positive real-valued monotonically non-decreasing functions.

The function g may be the identify function, so that g(x)=x for all real values of x. IARR may be 0.25. MMRR may be 0.05.

MMRR may be 0 so that, for n>1, RP(n)=g(min{MDRR, DRR(n−1)})*f(BC(n))*RPR(n).

MDRR may be relatively large so that RP(n)=g(DRR(n−1))*f(BC(n))*RPR(n). The function f may be the identity function so that RP(n)=g(DRR(n−1))*BC(n)*RPR(n).

The invention also provides a non-transitory computer-readable memory that has software instructions stored therein, the software instructions being adapted to run on a computer processor to cause the processor to calculate RP(n) using the methods described above.

The invention also provides a data recovery pricing system for pricing the recovery of data that has been backed up by a user to a data repository. The user has a backup capacity BC(n) for time period n, time period 1 being a first continuous time period and time period n being a continuous time period following time period n−1. n is a positive integer. BC(n) defines the maximum amount of data, expressed as a number of storage capacity units, that the user is permitted to store on the backup device during time period n. BC(n) being a positive real number. The system includes a computer processor, a non-transitory computer-readable memory accessible by the processor, and software stored in the memory for execution by the processor. The software causes the processor to calculate a Recovery Price for period n, RP(n). RP(1)=BC(1)*IARR*RPR(1), where IARR is a pre-defined real number greater than or equal to 0 referred to as the Initial Assumed Recovery Rate. RPR(n) is a Recovery Price Rate for time period n representing a pre-determined amount of money for each storage capacity unit. For n greater than 1, RP(n)=g(max{MMRR, min{MDRR, DRR(n−1)}})*f(BC(n))*RPR(n). MMRR is a pre-defined number greater than or equal to 0 referred to as the Minimum Mandatory Recovery Rate. MDRR is the maximum data recovery rate, which is a pre-defined real number greater than or equal to MMRR. DRR(n−1) is the Data Recovery Rate for period n−1 that is calculated as the number of storage capacity units of data that were recovered by the user in time period n−1 divided by BC(n−1). f and g are positive real-valued monotonically non-decreasing functions. The system displays the value of RP(n) for a given value of n to the user, or provides the value to a billing system.

### BRIEF DESCRIPTION OF THE DRAWINGS

FIG. 1 is a depiction of the connection of a number of user computer systems to a data repository that is managed by a license server.

### DETAILED DESCRIPTION OF THE INVENTION

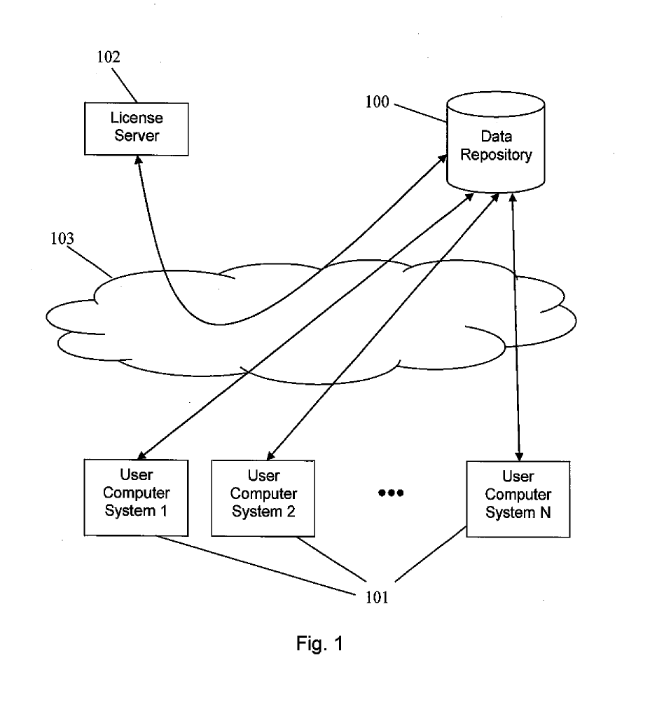

FIG. 1 shows a number, N, of customer computer systems 101 connected to a data repository 100 over a network, such as the internet 103 or a local area network. The data repository 100 is configured to receive data from the customer computer systems 101 for safe keeping (backup), back it up on a storage device, and to allow later recovery of portions of that backed up data. The data repository 100 keeps track of the backup and recovery activity of the customer's systems, deriving and maintaining recovery analytics information. A “storage device” may in fact comprise a large number of individual storage devices (such as hard drives), which may be co-located or may be distributed among a number of physical locations as long as they are all accessible on the same network.

A license server 102 governs and enforces the maximum amount of data, or backup capacity, that the customer may use for backup in any given time period. The license server 102 may also enforce a limit on the amount of data that a customer is allowed to recover. Time periods are generally indexed by the letter n, being a positive integer. The first time period, n=1, starts when the customer is first authorized to use the data repository 100 for backup and recovery, and generally ends a fixed time thereafter such as one year, one quarter or one month. Time period n preferably starts immediately upon the end of time period n−1, assuming the customer continues to subscribe to and pay for the service or license, although a gap between successive time periods is possible. Generally the time periods for a customer are all of the same length, but in some cases the duration may vary. The license server may respond to queries from the data repository 100 about a customer's status, e.g. to determine that the customer's license is currently in force and to confirm the customer's allocated backup and recovery limits. Then, if the data repository 100 receives a customer recovery request from a customer system, and the license server informs the data repository 100 that the license is no longer valid, the data repository 100 may return a suitable error to the customer system indicating that the license term needs to be extended. Similarly, if the customer tries to backup or recover more data than the customer's currently allocated capacity, the data repository 100 may return a suitable error to indicate to the customer system that the license needs to be amended to increase the capacity.

It should be noted that a “customer” as referenced herein may be a service provider who provides backup and recovery services to end users for a fee. In such cases, the service provider may provide the required data repositories. The service provider may license the backup and recovery software from a software licensor. The software licensor may charge the service provider based on a predefined maximum amount of backup capacity and the amount of data recovered. The service provider's customers or users may in turn pay the service provider based on actual or allocated backup capacity and amount of data recovered.

A customer's backup capacity for time period n will be referred to as BC(n), which is a positive real number measured in storage capacity units, such as bytes, kilobytes, megabytes, gigabytes, terabytes, petabytes, etc. For example, a customer in a third time period may have backup capacity BC(3)=10 TB. This may increase or decrease over time depending on the customer's needs. The backup capacity may define a maximum amount that the customer can use to backup data.

The customer obtains a license from the licensor for BC(n) in time period n for which it pays a fee to the licensor. However, rather than charging all customers a certain amount per storage capacity unit times BC(n) for all backup and recovery activity, the method decouples the pricing for backup and recovery. The customer will be charged a fixed amount per storage capacity unit, possibly subject to volume discounts or other adjustments, times BC(n) for backup capacity. However, for recovery, the method uses a Recovery Price Rate for time period n, RPR(n), representing a pre-determined amount of money for each storage capacity unit, which is multiplied by an estimate of the amount of data that will be recovered to calculate the Recovery Price. More precisely, the Recovery Price for period n, RP(n), is calculated as follows:

For the first time period, RP(1)=BC(1)*IARR*RPR(1), where IARR is a pre-defined real number greater than or equal to 0 referred to as the Initial Assumed Recovery Rate. IARR is preferably greater than 0 and less than or equal to 1. IARR may be fixed, such as 0.25, or it may be calculated based on information about the customer that is available. For example, the licensor may compile average values of data recovery rates indexed by variables such as the size of the customer, type of business, type of user equipment, etc. and use these to set IARR.

For subsequent time periods, n greater than 1, RP(n)=max{MMRR, DRR(n−1)}*BC(n)*RPR(n), where MMRR is a pre-defined number greater than or equal to 0 referred to as the Minimum Mandatory Recovery Rate, and DRR(n−1) is the Data Recovery Rate for period n−1 that is calculated as the number of storage capacity units of data that were actually recovered by the customer in time period n−1 divided by BC(n−1). The function max{x,y} is equal to the greater of x and y (i.e. max{x,y}=y if y>=x, and otherwise max{x,y}=x).

For example, the following costs would apply for DRR(n) as shown if MMRR=0.05, IARR=0.25.

| Time period | DRR | RP |
|---|---|---|
| 1 | 0.10 | 0.25 * BC(1) * RPR(1) |
| 2 | 0.20 | 0.10 * BC(2) * RPR(2) |
| 3 | 0.15 | 0.20 * BC(3) * RPR(3) |
| 4 | 0.02 | 0.15 * BC(4) * RPR(4) |
| 5 | 0.18 | 0.05 * BC(5) * RPR(5) |

In this example, the customer had an anomalously low amount of data recovery in period 4 and the RP in period 5 was based on the minimum factor of MMRR=0.05 rather than the previous period's actual use. In reality the amount recovered in period 5 was significantly higher. In general, the variation in DRR over time is expected to be relatively slow so that DRR(n−1) provides a reasonable estimate of the proportion of data that will be recovered in period n. Note that it is only the proportion that is being estimated. If the customer's capacity doubles in a subsequent period, it is that doubled capacity that is used to determine RP.

The maximum recovery rate that the customer has to pay may be capped. For example, by a pre-defined real number greater than or equal to MMRR, which may be referred to as MDRR (Maximum Data Recovery Rate). For example, the following costs would then apply for DRR(n) as shown if MMRR=0.05, IARR=0.25, and MDRR=0.25.

| Time period | DRR | RP |
|---|---|---|
| 1 | 0.10 | 0.25 * BC(1) * RPR(1) |
| 2 | 0.20 | 0.10 * BC(2) * RPR(2) |
| 3 | 0.32 | 0.20 * BC(3) * RPR(3) |
| 4 | 0.02 | 0.25 * BC(4) * RPR(4) |
| 5 | 0.18 | 0.05 * BC(5) * RPR(5) |
| 6 | 0.18 | 0.18 * BC(6) * RPR(6) |

More generally, we can define RP(n)=max{MMRR, DRR(n−1)}*f(BC(n))*RPR(n), where f is a monotonically non-decreasing positive real valued function. Many functions f of interest are of the form f(BC(n))=C*BC(n), where C is a positive constant, but the same result can be achieved by varying RPR(n). A function f, which is effectively a volume discount on backup capacity, may be useful. This could be for example, f(BC(n))=BC(n) for BC(n)<10 TB, f(BC(n))=0.95*BC(n) for 10 TB<=BC(n)<=20 TB, and f(BC(n))=0.90*BC(n) for BC(n)>20 TB. In general, f will be the identify function, f(BC(n))=BC(n).

Further adjustments may be made to the pricing model. For example, the single largest recovery event in a time period may be excluded when calculating DRR(n).

In general, the price RP(n) is the price for the customer to recover at most DRR(n−1)*BC(n) in time period n. This may also be a cap so that the customer pays only this amount no matter how much is recovered in time period n. However, it is preferred that, if the customer recovers more than DRR(n−1)*BC(n), then RP(n) is increased to min{DRR(n), MDRR}*BC(n)*RPR(n), where MDRR is the Maximum Data Recovery Rate, which is a pre-defined real number greater than or equal to MMRR. In this way, the customer pays for additional recovery but only up to a pre-determined limit or “cap”. MDRR may be set equal to IARR, for example. Alternatively, MDRR may be set equal to 0.25, for example, irrespective of the selected value of IARR. The function min{x,y} is equal to the lesser of x and y (i.e. min{x,y}=y if y<=x, and otherwise min{x,y}=x). As above, this may be generalized by replacing BC(n) with f(BC(n)).

The licensor may also provide tracker software to run on a computer system/server that is generally near the data repository 100. The tracker obtains recovery analytics from the data repository 100, and displays such data, on request to customer staff. Metrics that may be displayed by the tracker include:
Total Data Backed-up
% Total Data Recovered by Enterprise
Recovery Frequency
Recovery Reason
Recovery Source
Comparison with Industry Average
Cost savings compared to other pricing models

These metrics may be broken down, for example, by department. Recovery source may include physical servers, virtual machines, desktop computers, email database and mobile devices. Recovery reasons may include human error, natural disaster, hardware failure, software failure, virus, theft and lost device. The tracker may present visualizations, such as a graph of amount of data recovered by time.

It is not necessary that the time period durations be the same or be fixed. For example, time period 1 may be shorter than the others. In some embodiments, the length of a time period may be determined by the number of storage capacity units of data that were recovered by the customer since the beginning of that time period. For example, time period n may end when DRR(n−1)*BC(n) has been recovered in time period n, or a multiple of this, such as 1.25.

DRR is necessarily measured by a computer-based system, which system may also compute the values of RP(n).

DRR may alternately be used to compute a ranking or score. For example a Recovery Performance Score for period n (RPS(n)) may be calculated as RPS(n)=INT(10*[(MDRR−MMRR)−min{(MDRR−MMRR), max{(DRR(n−1)−MMRR), 0}]/(MDRR−MMRR)), where INT(x) is the greatest integer less than or equal to x. For example, if MDRR=0.25 and MMRR=0.05, then RPS(n)=50*[0.2−min{0.2, max{(DRR(n−1)−0.05), 0)]. Then if DRR(n−1) is 0.05 or less, RPS(n)=10, and if DRR(n−1) is 0.25 or greater, then RPS(n)=0. If DRR(n−1) is in the range 0.05 to 0.25, then RPS(n)=INT(50*[0.25−DRR(n−1)]). RPS(1) may be set equal to 1.

Then RP(n) may alternatively be calculated as [MMRR+(1−RPS(n)/10)*(MDRR−MMRR)]*f(BC(n))*RPR(n). In this case, the first factor varies from MMRR when RPS(n)=10, to MDRR when RPS(n)=0. The use of such a discrete performance score such that price decreases as the score increases may be preferable to users.

In an extended/alternate embodiment, we can define RP(n)=g(max{MMRR, min{MDRR, DRR(n−1)}})*f(BC(n))*RPR(n), where g is preferably a monotonically non-decreasing positive real valued function. The first factor, which, for suitable choices of MMRR and MDRR, reduces to g(DRR(n−1)), can be used to vary the cost of recovery based on the amount of recovery performed in the prior period. For example, if f is the identity function, MMRR=0.05, MDRR=0.25, RPR(n)=$3.40, then g may be defined, for example, so that g(x)=0.05+0.485*(x−0.05) and the following may be calculated.

| | | RP(n)/BC(n) - Recovery price per unit of |
|---|---|---|
| DRR(n − 1) | g(DRR(n − 1)) | storage capacity |
| 0.05 | 0.05 | $0.17 |
| 0.10 | 0.074 | $0.25 |
| 0.15 | 0.10 | $0.34 |
| 0.20 | 0.123 | $0.42 |
| 0.25 | 0.147 | $0.50 |

In the above example, g(x)=0.05+0.485*(x−0.05), although any suitable function g may be employed. A preferred function is of the form g(x)=C1+C2*(x−MMRR) where C1 and C2 are constants, preferably less than 1.0. C1 may be selected to be equal to MMRR.

Such a formulation may also be used in combination with a scoring system. For example, RP(n) may alternatively be calculated as RP(n)=g1([MMRR+(1−RPS(n)/10)*(MDRR−MMRR)])*f(BC(n))*RPR(n), where g1 is a monotonically non-increasing positive real valued function.

The values of RP(n) are computer by a computer processor, generally being a programmable processor executing software configured to calculate RP(n) as described above, the software being stored in a non-transitory memory accessible by the processor. The computed values may be displayed to a user and/or passed to a billing system over an electronic network.

Generally, a computer, computer system, computing device, client or server, as will be well understood by a person skilled in the art, includes one or more than one computer processor, and may include separate memory, and one or more input and/or output (I/O) devices (or peripherals) that are in electronic communication with the one or more processor(s). The electronic communication may be facilitated by, for example, one or more busses, or other wired or wireless connections. In the case of multiple processors, the processors may be tightly coupled, e.g. by high-speed busses, or loosely coupled, e.g. by being connected by a wide-area network.

A computer processor, or just “processor”, is a hardware device for performing digital computations. A programmable processor is adapted to execute software, which is typically stored in a computer-readable memory. Processors are generally semiconductor based microprocessors, in the form of microchips or chip sets. Processors may alternatively be completely implemented in hardware, with hard-wired functionality, or in a hybrid device, such as field-programmable gate arrays or programmable logic arrays. Processors may be general-purpose or special-purpose off-the-shelf commercial products, or customized application-specific integrated circuits (ASICs). Unless otherwise stated, or required in the context, any reference to software running on a programmable processor shall be understood to include purpose-built hardware that implements all the stated software functions completely in hardware.

Multiple computers (also referred to as computer systems, computing devices, clients and servers) may be networked via a computer network, which may also be referred to as an electronic network or an electronic communications network. When they are relatively close together the network may be a local area network (LAN), for example, using Ethernet. When they are remotely located, the network may be a wide area network (WAN), such as the internet, that computers may connect to via a modem, or they may connect to through a LAN that they are directly connected to.

Computer-readable memory, which may also be referred to as a computer-readable medium or a computer-readable storage medium, which terms have identical (equivalent) meanings herein, can include any one or a combination of non-transitory, tangible memory elements, such as random access memory (RAM), which may be DRAM, SRAM, SDRAM, etc., and nonvolatile memory elements, such as a ROM, PROM, FPROM, OTP NVM, EPROM, EEPROM, hard disk drive, solid state disk, magnetic tape, CDROM, DVD, etc.). Memory may employ electronic, magnetic, optical, and/or other technologies, but excludes transitory propagating signals so that all references to computer-readable memory exclude transitory propagating signals. Memory may be distributed such that at least two components are remote from one another, but are still all accessible by one or more processors. A nonvolatile computer-readable memory refers to a computer-readable memory (and equivalent terms) that can retain information stored in the memory when it is not powered. A computer-readable memory is a physical, tangible object that is a composition of matter. The storage of data, which may be computer instructions, or software, in a computer-readable memory physically transforms that computer-readable memory by physically modifying it to store the data or software that can later be read and used to cause a processor to perform the functions specified by the software or to otherwise make the data available for use by the processor. In the case of software, the executable instructions are thereby tangibly embodied on the computer-readable memory. It is the express intent of the inventor that in any claim to a computer-readable memory, the computer-readable memory, being a physical object that has been transformed to record the elements recited as being stored thereon, is an essential element of the claim.

Software may include one or more separate computer programs configured to provide a sequence, or a plurality of sequences, of instructions to one or more processors to cause the processors to perform computations, control other devices, receive input, send output, etc.

It is intended that the invention includes computer-readable memory containing any or all of the software described herein. In particular, the invention includes such software stored on non-volatile computer-readable memory that may be used to distribute or sell embodiments of the invention or parts thereof.

It should be understood that the above-described embodiments of the present invention, particularly, any “preferred” embodiments, are only examples of implementations, merely set forth for a clear understanding of the principles of the invention. Many variations and modifications may be made to the above-described embodiment(s) of the invention as will be evident to those skilled in the art.

Where, in this document, a list of one or more items is prefaced by the expression “such as” or “including”, is followed by the abbreviation “etc.”, or is prefaced or followed by the expression “for example”, or “e.g.”, this is done to expressly convey and emphasize that the list is not exhaustive, irrespective of the length of the list. The absence of such an expression, or another similar expression, is in no way intended to imply that a list is exhaustive. Unless otherwise expressly stated or clearly implied, such lists shall be read to include all comparable or equivalent variations of the listed item(s), and alternatives to the item(s), in the list that a skilled person would understand would be suitable for the purpose that the one or more items are listed.

The words “comprises” and “comprising”, when used in this specification and the claims, are to used to specify the presence of stated features, elements, integers, steps or components, and do not preclude, nor imply the necessity for, the presence or addition of one or more other features, elements, integers, steps, components or groups thereof.

The scope of the claims that follow is not limited by the embodiments set forth in the description. The claims should be given the broadest purposive construction consistent with the description as a whole.

1. The method of claim 13, wherein g is the identity function, and wherein MDRR is sufficiently large {MDRR, DRR(n−1)}=DRR(n−1) for any n greater than 1, so that the pricing method calculates, by a computer processor, the Recovery Price for period n, RP(n), for n greater than 1, as:
RP(n)=max{MMRR, DRR(n−1)}*f(BC(n)*RPR(n).

2. The method of claim 1, wherein IARR is 0.25.

3. The method of claim 1, wherein MMRR is 0 so that, for n>1, RP(n)=DRR(n−1)*f(BC(n))*RPR(n).

4. The method of claim 1, wherein MMRR is 0.05.

5. The method of claim 1, wherein if DRR(n) exceeds DRR(n−1) then DRR(n−1) the RP(n) is increased to min{DRR(n), MDRR}*f(BC(n))*RPR(n), where MDRR is the maximum data recovery rate, which is a pre-defined real number greater than or equal to MMRR.

6. The method of claim 5, wherein MDRR is equal to IARR.

7. The method of claim 1, wherein the storage capacity unit is a byte, kilobyte, megabyte, gigabyte, terabyte or petabyte.

8. The method of claim 1, wherein each of the time periods is equal to one hour, each of the time periods is equal to one day, each of the time periods is equal to one month or each of the time periods is equal to one year.

9. The method of claim 1, wherein the length of each of the time periods is a function of the number of storage capacity units of data that were recovered by the user since the beginning of that time period.

10. The method of claim 1, wherein f is the identify function, so that f(BC(n))=BC(n).

11. The data recovery pricing method of claim 1, further comprising:
(a) providing a data repository to which a user can backup data and from which the user can recover data;
(b) providing a tracker, the tracker being software for running on a computer processor that measures the number of storage capacity units of data that the user recovers from the data repository; and
(c) for at least time periods n=1 and n=2, charging the user a price equal to RP(n) for time period n, which for n greater than 1 is based on DRR(n−1) measured by the tracker.

12. The data backup and recovery method of claim 11, further comprising the step of providing a license server, the license server being software running on a computer processor configured to verify that the user has a valid license to recover data from the data repository.

13. A data recovery pricing method for pricing the recovery of data that has been backed up by a user to a data repository, the user having a backup capacity BC(n) for time period n, time period 1 being a first continuous time period and time period n being a continuous time period following time period n−1, where n is a positive integer, BC(n) defining the maximum amount of data, expressed as a number of storage capacity units, that the user is permitted to store on the backup device during time period n, BC(n) being a positive real number, wherein the pricing method calculates, by a computer processor, a Recovery Price for period n, RP(n), as:
RP(1)=BC(1)*IARR*RPR(1), where IARR is a pre-defined real number greater than or equal to 0 referred to as the Initial Assumed Recovery Rate, and RPR(n) is a Recovery Price Rate for time period n representing a pre-determined amount of money for each storage capacity unit; and
for n greater than 1, RP(n)=g(max{MMRR, min{MDRR, DRR(n−1)}})*f(BC(n))*RPR(n), where MMRR is a pre-defined number greater than or equal to 0 referred to as the Minimum Mandatory Recovery Rate, MDRR is the maximum data recovery rate, which is a pre-defined real number greater than or equal to MMRR, DRR(n−1) is the Data Recovery Rate for period n−1 that is calculated as the number of storage capacity units of data that were recovered by the user in time period n−1 divided by BC(n−1), and f and g are positive real-valued monotonically non-decreasing functions.

14. The method of claim 14, wherein g is the identify function, so that g(x)=x for all real values of x.

15. The method of claim 14, wherein IARR is 0.25

16. The method of claim 14, wherein MMRR is 0.05.

17. The method of claim 14, wherein MMRR is 0 so that, for n>1, RP(n)=g(min{MDRR, DRR(n−1)})*f(BC(n))*RPR(n).

18. The method of claim 17, wherein MDRR is relatively large so that RP(n)=g(DRR(n−1))*f(BC(n))*RPR(n).

19. The method of claim 18, wherein f is the identity function so that RP(n)=g(DRR(n−1))*BC(n)*RPR(n).

20. A data recovery pricing system for pricing the recovery of data that has been backed up by a user to a data repository, the user having a backup capacity BC(n) for time period n, time period 1 being a first continuous time period and time period n being a continuous time period following time period n−1, where n is a positive integer greater than 1, BC(n) defining the maximum amount of data, expressed as a number of storage capacity units, that the user is permitted to store on the backup device during time period n, BC(n) being a positive real number, the system comprising:
a computer processor;
a non-transitory computer-readable memory accessible by the processor;
software stored in the memory for execution by the processor, wherein the software causes the processor to calculate a Recovery Price for period n, RP(n), as:
RP(1)=BC(1)*IARR*RPR(1), where IARR is a pre-defined real number greater than or equal to 0 referred to as the Initial Assumed Recovery Rate, and RPR(n) is a Recovery Price Rate for time period n representing a pre-determined amount of money for each storage capacity unit; and
for n greater than 1, RP(n)=g(max{MMRR, min{MDRR, DRR(n−1)}})*f(BC(n))*RPR(n), where MMRR is a pre-defined number greater than or equal to 0 referred to as the Minimum Mandatory Recovery Rate, MDRR is the maximum data recovery rate, which is a pre-defined real number greater than or equal to MMRR, DRR(n−1) is the Data Recovery Rate for period n−1 that is calculated as the number of storage capacity units of data that were recovered by the user in time period n−1 divided by BC(n−1), and f and g are positive real-valued monotonically non-decreasing functions,
wherein the system displays the value of RP(n) for a given value of n to the user, or provides the value to a billing system.
